(19) United States
(12) Patent Application Publication
(10) Pub. No.: US 2026/0250996 A1
(43) Pub. Date: Aug. 27, 2026

(54) RAIL DEVICE AND FUNCTIONAL ENTITY

(71) Applicant: HAWA SLIDING SOLUTIONS AG, Mettmenstetten (CH)

(72) Inventors: Marco TUBERGA, Hedingen (CH); Cédric URECH, Oberentfelden (CH)

(73) Assignee: HAWA SLIDING SOLUTIONS AG, Mettmenstetten (CH)

(21) Appl. No.: 19/161,907

(22) PCT Filed: Mar. 4, 2024
(86) PCT No.: PCT/EP2024/055539

§ 371 Date: Sep. 3, 2025

(30) Foreign Application Priority Data
Mar. 16, 2023 (EP) 23162443.8

(51) Int. Cl. E05D 15/58; E05D 15/26

(52) U.S. Cl. CPC E05D 15/58; E05D 15/264; E05Y 2201/684; E05Y 2800/205

(57) ABSTRACT

A rail device includes a first rail section with a support body and guide channel, a second rail section with a support body and guide channel, and a connection device by which end pieces of the two sections interconnect. The rail device includes a rail adapter, by which the first and second rail sections connect at a selectable mutual distance, the rail adapter has a third support body and guide channel, the first rail section end piece has a recess wherein the rail adapter completely or partially displaces, the first, second and third support bodies are aligned coaxially and form a support track to support the support rollers, and that the first, second and third guide channels align coaxially to one another and have a completely or partially identical internal cross-section and form a first guide track or a first and a second guide track, to guide the guide rollers.

The invention relates to a rail device with at least two interconnected rail sections and a functional entity, particularly a piece of furniture, with at least one such rail device.

To close off functional units, such as openings in rooms or pieces of furniture, separating elements, possibly foldable separating elements such as folding doors or foldable sliding doors, are used. Preferably, partition elements are provided that are moved into a door compartment or parking space after the opening has been released so as not to be obtrusive.

U.S. Pat. No. 9,284,761B2 discloses a piece of furniture with a displacement device, by means of which a mounting profile connected to a foldable sliding door is displaceable within a door compartment. The foldable sliding door comprises two door elements, of which the first door element is connected at the rear by mounting hinges to the mounting profile and at the front by door hinges to the rear of a second door element, which is connected at the front to a guide carriage. The mounting profile is held in vertical alignment by a support device and is provided at the top and bottom with support runners which are guided in a support rail. The guide carriage can be moved along a rail device, which has three rail sections, of which a first and a second rail section are connected to each other by a third rail section running along a curve. The first rail section extends straight into the door compartment and the second rail section extends straight along the front of the piece of furniture. The guide carriage is therefore movable between a first end stop and a second end stop by means of the guide rail.

To close the piece of furniture, the foldable door is moved out of the door compartment and unfolded. In the closed position, the door elements are aligned planar to each other. To open the piece of furniture, the foldable door is refolded, with the door elements preferably aligned parallel to each other in an open position and retracted into the door compartment.

For functional and aesthetic reasons, it is usually desirable that the rail device has a prescribed length in all sectors so that rail sections extend precisely to the next rail section or precisely to a wall. When installing a functional entity, it is therefore often necessary to cut rail sections to a required length and, if necessary, adapt them to the functional entity, which may deviate from the intended dimensions. The installation of the rail device and thus the functional entity can therefore require considerable effort and the provision of metalworking tools.

JP2009299305A relates to a cabinet which has a selectable number of sections which can be closed by means of sliding doors or foldable sliding doors which can be moved along a guide rail by means of guide carriages. Regarding the selectable number of sections of this cabinet, it is not possible to provide a single guide rail. Instead, rail sections must be provided for each of the sections of the cabinet. The individual rail sections are joined together in a sealed manner by means of a connecting structure comprising a metal plate and two insert plates. The insert plates are made of a rubber-like sealing material and are each glued to one side of the metal plate. The two insert plates and the metal plate held between the insert plates are inserted between the facing end faces of the rail sections. To ensure that the metal plate and the insert plates are held coaxially to the rail sections, connecting rods are provided which pass through the insert plates and the metal plate and are held in the rail sections. Finally, the rail sections, which are provided with angle pieces, are pulled against each other using connecting screws. The connection device of JP2009299305A is therefore used to connect two rail sections to each other in a sealed manner. The resulting distance between the end faces of the rail sections facing each other is fixed. According to JP2009299305A, there is no provision for adjusting this distance. The force with which the rail sections are pulled against the insertion plates is to be kept within a range in which the insertion plates are held tightly but are not damaged by excessive pressure. It is therefore virtually impossible to adjust the distance between the end faces of the rail sections.

WO2018204952A1 discloses a guide system for guiding a furniture door with a guide rail comprising a first and a second rail section which can be connected to one another by a connecting piece of a fixed size. It is not possible to adjust the distance between the end faces of the rail sections.

WO2018204952A1 discloses a further guide system for guiding a furniture door with a guide rail comprising a first and a second rail section which are connectable to each other by a connecting piece of a fixed size. In this device the connecting piece is connectable to a part of the furniture to hold the interconnected end pieces of the rail sections. Also with this device, it is not possible to adjust the distance between the ends of the rail sections.

The present invention is therefore based on the object of creating an improved rail device which has at least two rail sections, as well as a functional entity with such a rail device.

The inventive rail device shall be installable with little effort and without metalworking tools. In particular, there shall be no need to cut rail sections to size. The provision of differently dimensioned connecting pieces shall also be avoided. It shall therefore be possible to supply rail sections for a functional entity with predefined dimensions in standard sizes.

The rail device shall allow to carry and/or guide one or more carriages optimally. The rail device shall also be suitable for holding and guiding any type of carriage.

Carriages shall be movable in the rail device as silently and with as little wear as possible. Disruptive transitions or gaps between the rail sections shall be avoided.

Furthermore, the rail device should appear in a favourable way.

This problem is solved with a rail device according to claim 1 and a functional entity, optionally a piece of furniture, according to claim 15. Advantageous embodiments of the invention are defined in further claims.

The rail device, by means of which a carriage, which has at least one support roller and two guide rollers, can be guided along a rail axis, comprises a first rail section with a first support body and a first guide channel, a second rail section with a second support body and a second guide channel, and a connection device, by means of which facing end pieces of the two rail sections are connected to one another.

According to the invention
the rail device comprises a rail adapter, by means of which the first rail section (21) and the second rail section are connectable to one another at a selectable mutual distance,
the rail adapter has a third support body, and a third guide channel,
the end piece of the first rail section has a recess into which the rail adapter is completely or partially displaced,
that the first, second and third support bodies are aligned coaxially with each other and form a support track which serves to support the support rollers, and
that the guide channels of the first and second rail section and the rail adapter are aligned coaxially to each other and have a completely or partially identical internal cross-section and form a first guide track or a first and a second guide track, which serve to guide the guide rollers.

The rail adapter can therefore be moved fully or partially into the facing end piece of the first rail section, which is why the distance between the facing end pieces of the first rail section and the second rail section can be adjusted as required. It is therefore not necessary to cut the rail sections to size when installing the rail device, which is why rail sections can be provided in standard sizes or standard lengths.

The rail adapter is adjustable or can be selectively moved into the associated end piece of the first rail section, which is why the rail adapter is also referred to as an adjustable rail adapter.

The mounting of the rail device in a functional entity, for example in a piece of furniture, can be carried out quickly and with little effort and in particular without metalworking tools.

The rail adapter or the front piece of the rail adapter appears between the two rail sections. This solution not only provides a favourable connection between the rail sections. The rail adapter also provides a favourable aesthetic feature.

The first and second rail sections are preferably made of metal. The rail adapter, on the other hand, can be made of metal or, particularly cost-effectively, plastic. A colour or combination of colours can be selected for the rail adapter that is visually advantageous. Instead of a mechanical transition between the rail sections, which may appear unfavourable, the result is a striking visual transition that can be designed as desired. The distance between the two rail sections does not matter. The rail adapter between them is always a distinctive feature.

The rail elements for supporting and guiding the support rollers and guide rollers and/or stabilisation rollers can be arranged as desired.

In a preferred embodiment, it is provided,
that the first rail section comprises a first front wall, on which the first support body is provided, and a first head piece, in which the first guide channel is provided;
that the second rail section comprises a second front wall, on which the second support body is provided, and a second head piece, in which the second guide channel is provided; and
that the rail adapter comprises a third front wall, on which the third support body is provided, and a third head piece, in which the third guide channel is provided.

Hence, the rail device can be provided for carriages that have one or more support rollers, one or more guide rollers and one or more stabilisation rollers. The support rollers are intended to bear the load of the associated separating element. The guide rollers are intended to prevent the carriage from rotating about a vertical axis and moving transversely to the direction of travel. The optional stabilisation roller is typically intended to keep the carriage in vertical alignment.

In preferred embodiments, it is therefore optionally provided that the first rail section has a first stabilisation channel, the second rail section has a second stabilisation channel and the rail adapter has a third stabilisation channel, which stabilisation channels are aligned coaxially with one another and have a completely or partially identical internal cross-section and form a first stabilisation track or a first and a second stabilisation track, which serve to guide the stabilisation rollers.

Preferably, the first stabilisation channel is provided in the first support body, the second stabilisation channel in the second support body and the third stabilisation channel in the third support body. The support roller of the carriage can therefore roll on the upper side of the support body, while the stabilisation roller can engage in the stabilisation channel on the underside of the support body.

The dimensions of the rail adapter are completely or partially complementary to the recess in the end piece of the first rail section. The rail adapter can therefore be at least partially inserted into the associated end piece of the first rail section, whereby the recess is or can be at least partially refilled according to the dimensions of the removed material due to the complementary design of the rail adapter.

The rail adapter can be fully or partially inserted into the end piece of the first rail section, but preferably protrudes axially outwards regardless of the degree of mutual displacement.

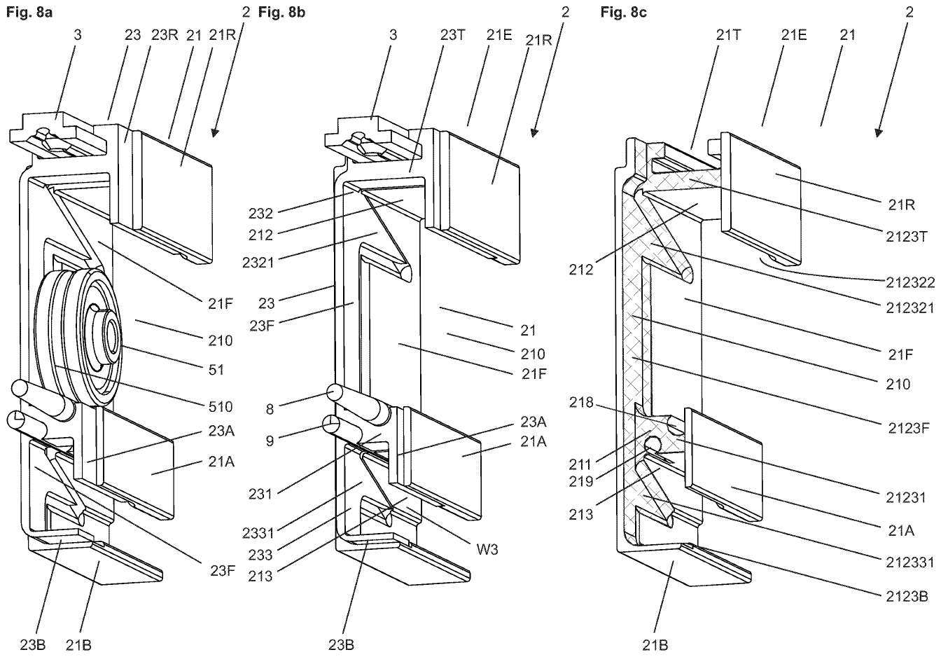

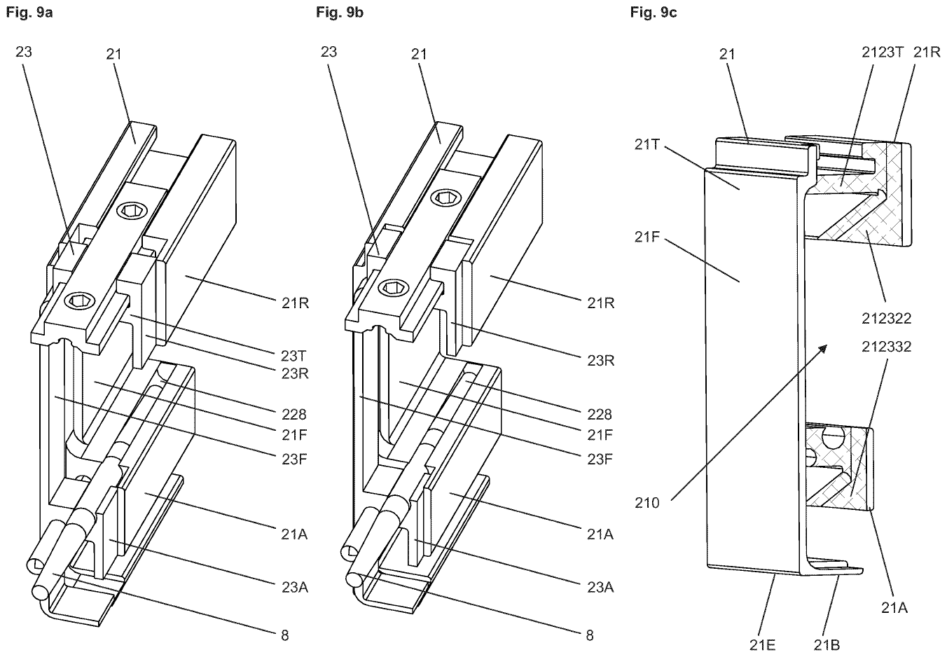

The recess can be worked or moulded into the end piece of the first rail section by mechanical processing, such as milling, or by moulding and casting. FIGS. 8c and 9c therefore show machining marks that indicate the milling.

Preferably it is provided,
that a part of the support body of the first rail section and a part of the support body of the rail adapter, which contribute to the formation of the Support track, are displaced sideways relative to each other during the displacement of the rail adapter, and/or
that a part of the guide channel of the first rail section and a part of the guide channel of the rail adapter, which contribute to the formation of the guide tracks, are displaced relative to each other during the displacement of the rail adapter above and below, and/or
that a part of the stabilisation channel of the first rail section and a part of the stabilisation channel of the rail adapter, which contribute to the formation of the stabilisation tracks, are displaced one above the other when the rail adapter is moved.

These measures ensure that the support roller and/or the guide rollers and/or the stabilisation rollers are always in contact with a part of the support track, a part of the guide track and a part of the stabilisation track, even in the transition area between the rail sections. In the transition area, the support roller and/or the guide rollers and/or the stabilisation rollers are always in contact with a part of the first support body and a part of the third support body and/or a part of the first guide channel and a part of the third guide channel and/or a part of the first stabilisation channel and a part of the third stabilisation channel. This results in a controlled and step-free transfer of the carriage from the first rail section to the rail adapter and preferably on to the second rail section. The transition from the rail adapter to the second rail section can be realised with the same or different dimensions as the transition from the rail adapter to the first rail section. The facing end piece of the second rail section can therefore also have a recess into which the rail adapter is inserted. Preferably, however, the rail adapter and the end of the second rail section are flush with each other.

In preferred embodiments, it is provided,
that the first rail section in the first guide channel has a recessed part into which a complementary and outwardly tapering guide wing of the third guide channel of the rail adapter projects, or
that the first rail section in the first guide channel has a recessed part on opposite sides, into which complementary and outwardly tapering guide wings of the third guide channel of the rail adapter project.

The guide wings of the rail adapter, which protrude into the first guide channel of the first rail section, serve as auxiliary bars onto which the guide rollers can pass while they are still guided in the first guide channel.

In a further preferable embodiment, it is provided
that the first rail section in the first stabilisation channel has a recessed part into which a complementary and outwardly tapering stabilisation wing of the third stabilisation channel of the rail adapter projects, or
that the first rail section in the first stabilisation channel has a recessed part on opposite sides, into which the complementary and outwardly tapering stabilisation wings of the third stabilisation channel of the rail adapter project.

The stabilisation wings of the rail adapter, which protrude into the first stabilisation channel of the first rail section, serve as auxiliary bars onto which the stabilisation roller can move while it is still guided in the first stabilisation channel.

Preferably, the guide wings and/or the stabilisation wings each have two flanks that are inclined towards each other. For example, the guide wings and/or the stabilisation wings are triangular or trapezoidal in shape so that they can interact with complementary parts of the first guide channel, which may also be triangular or trapezoidal in shape.

It should be noted that the load of the separating element, possibly the load of a door or folding/sliding door, is transferred to the rail device via the support rollers of the carriage.

In preferred embodiments, the support bodies of the first and second rail sections and the rail adapter have a reception channel into which a runner bar is inserted, which projects beyond the third support body of the rail adapter and is preferably tapered on one or both sides. The runner bar is held on both sides in the receiving channels of the first and second rail sections and can therefore absorb high loads. The support roller of the carriage is preferably provided with a ring groove into which the runner bar can enter when the carriage passes over it. The support roller is thus stably supported and safely guided by the runner bar.

In a further preferable embodiment, the first and second rail sections and the rail adapter each have at least one mounting channel, into which mounting channels, which are aligned coaxially to one another, a connecting rod is inserted. Preferably, the mounting channels are inserted into the support bodies of the first and second rail sections and the rail adapter, so that the support body of the rail adapter is held stable.

In a further preferable embodiment, it is provided that the head pieces of the first and second rail section and of the rail adapter each have an installation channel, which installation channels are aligned coaxially to one another, that the connection device has a connection plate and locking screws held rotatably in the connection plate and that the connection plate is held axially displaceably in the installation channels and is fixed by means of the locking screws. In this way, the two rail sections and the rail adapter located between them can be connected to each other in a simple manner.

The inventive solution can be used advantageously for any rail device. The first and second rail sections can each extend straight or at least partially along a curve. However, the first rail section can also extend straight and the second rail section can extend at least partially along a curve, or vice versa.

The inventive rail device can be advantageously installed and used in any functional unit, especially in furniture. An inventive rail device can also have more than two rail sections and more than one adjustable rail adapter.

The invention is explained in more detail below with reference to drawings. It shows:

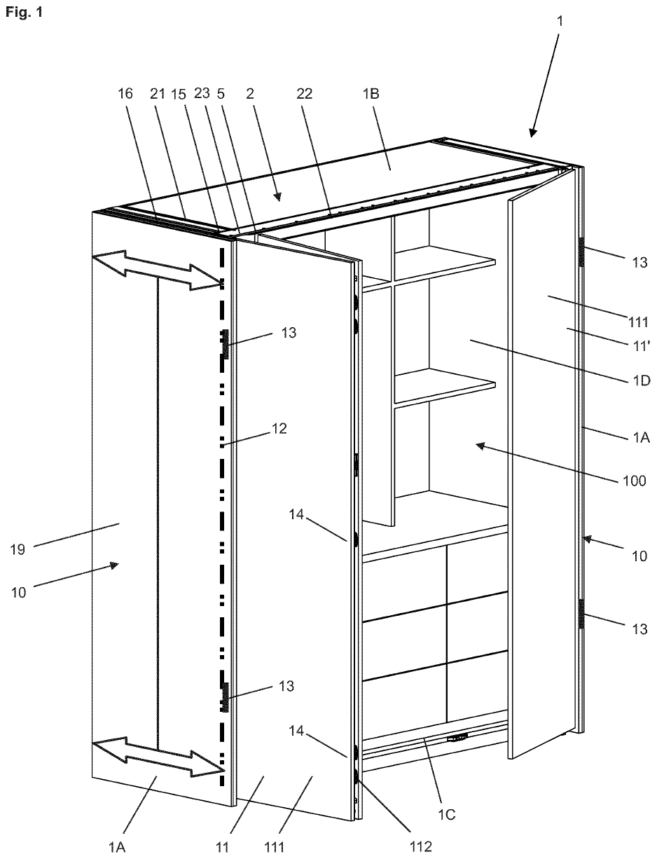

FIG. 1 an inventive functional entity 1 in the form of a piece of furniture with a foldable door 11 with two door elements 111, 112 connected to one another by door hinges 14 and a rail device 2, which has a first rail section 21 extending along a curve and a second rail section 22 extending along the front of the functional entity 1, which are connected to one another by an adjustable rail adapter 23, and in which a guide carriage 5, which holds one of the door elements 112 of the foldable door 11, is displaceably mounted;

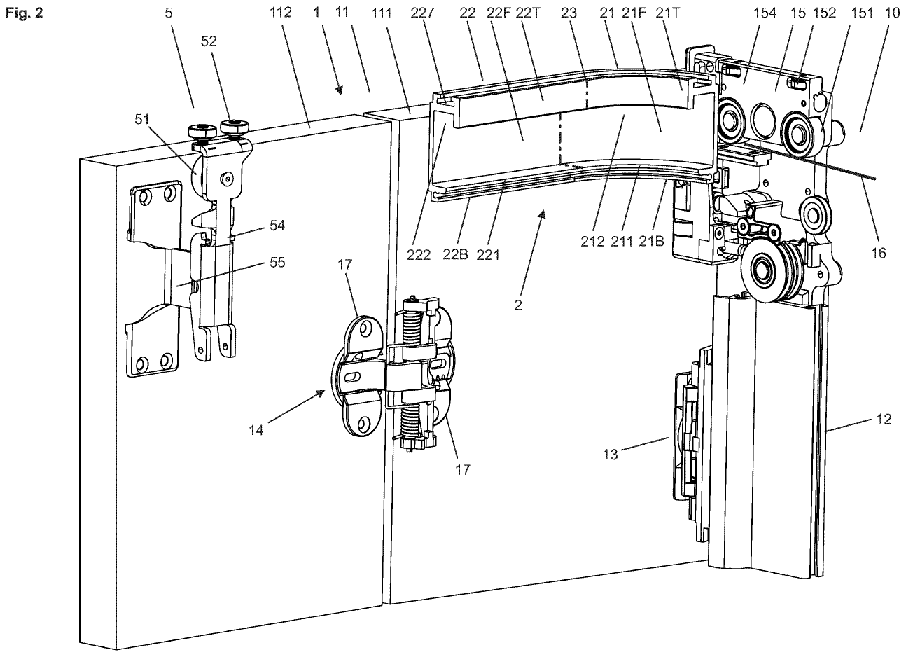

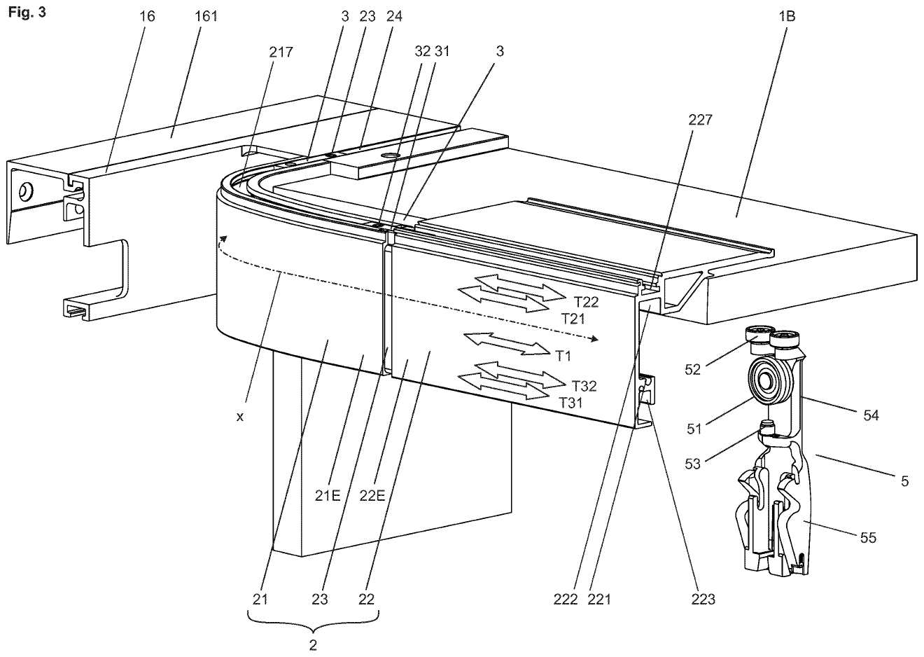

FIG. 2 the rear side of the foldable door 11 of the functional entity 1 of FIG. 1 with the first door element 111, which is connected at the trailing edge by mounting hinges 13 to a mounting profile 12 and at the leading edge by door hinges 14 to the second door element 112, on which the guide carriage 5 is mounted and the rail device 2 with the first and second rail sections 21 and 22, which are shown shortened and are connected to each other by the rail adapter 23, which is shown schematically;

FIG. 3 the rail device 2 and the guide carriage 5 of FIG. 2 in a preferred embodiment from the font side;

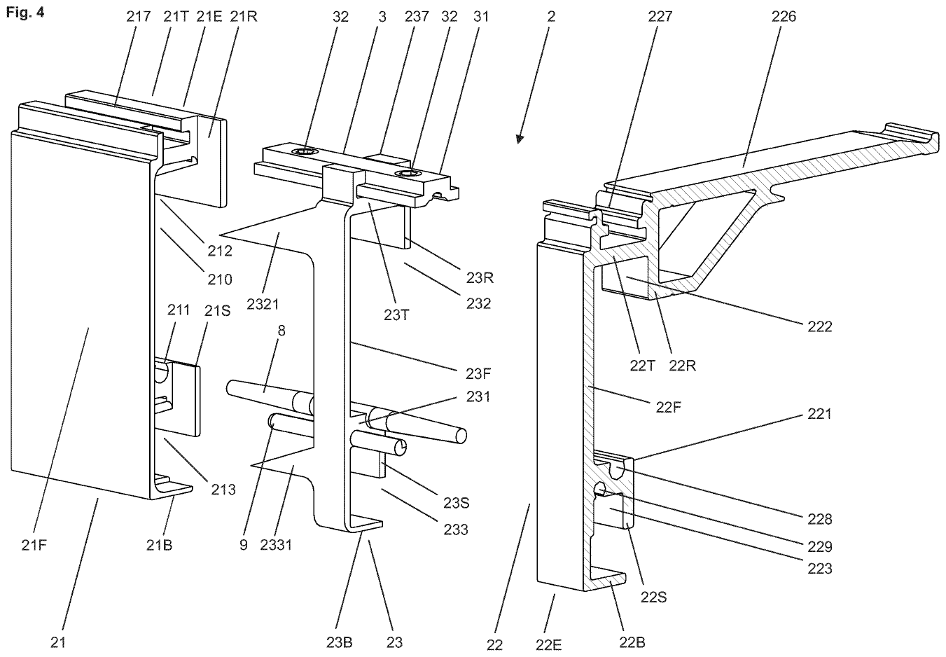

FIG. 4 the end piece 21E of the first rail section 21 of FIG. 3, which has a recess 210 for completely or partially receiving the rail adapter 23, the exposed rail adapter 23 and the end piece 22E of the second rail section 22 facing the rail adapter 23;

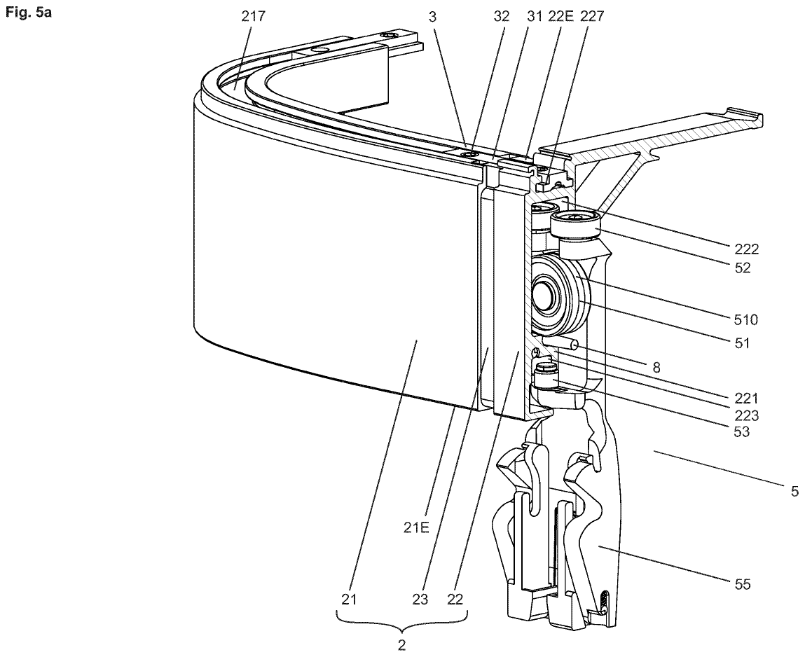

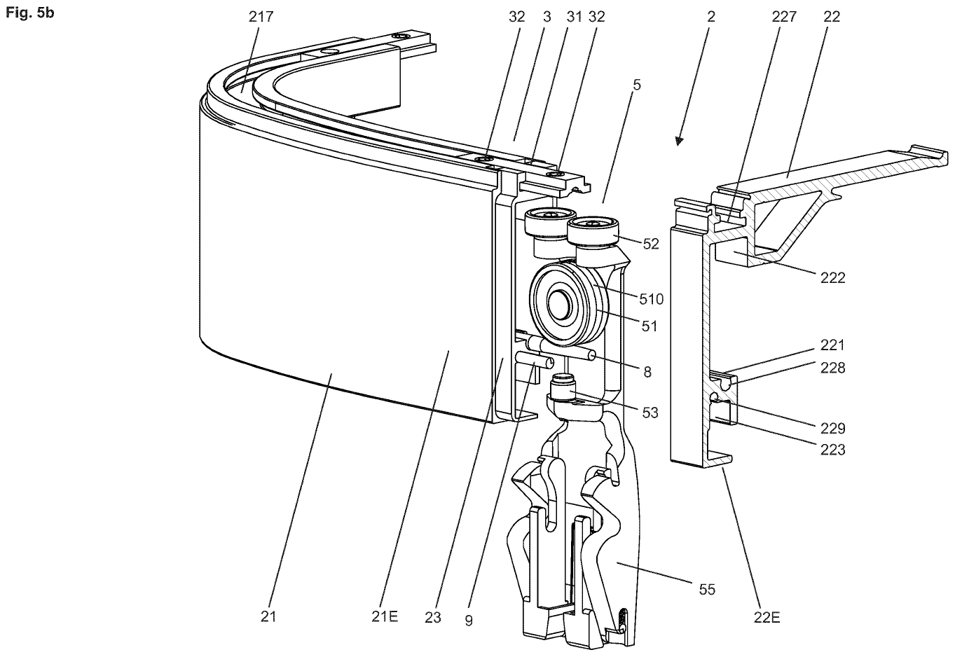

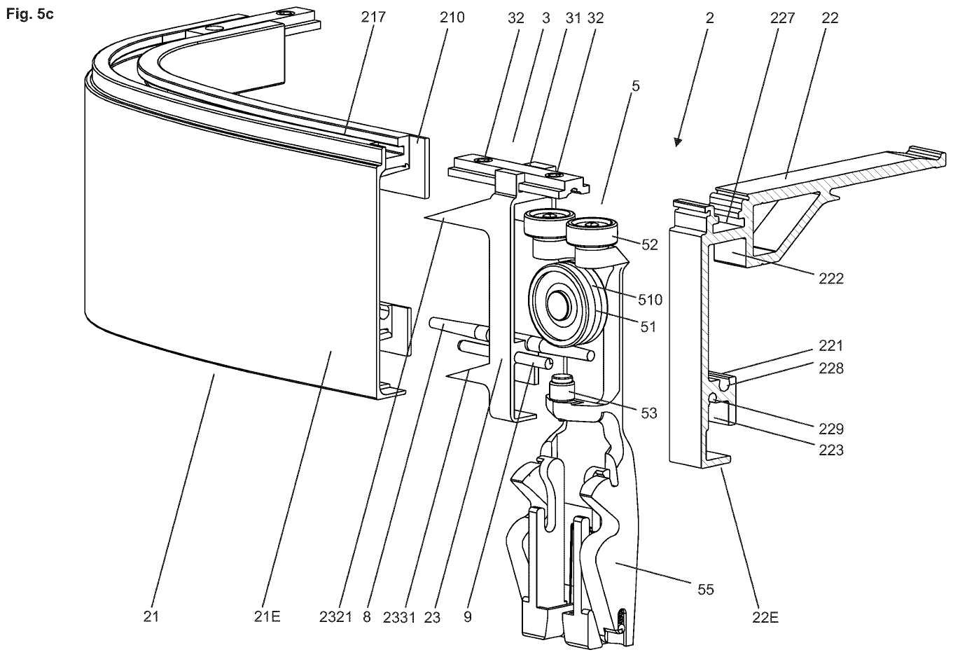

FIG. 5a the rail device 2 of FIG. 3 with the second rail section 22 in sectional view and with guide carriage 5 inserted;

FIG. 5b the rail device 2 of FIG. 3 with the second rail section 22 detached from the rail adapter 23;

FIG. 5c the rail device 2 of FIG. 3 with the rail adapter 23 from which the first rail section 21 and the second rail section 22 are detached;

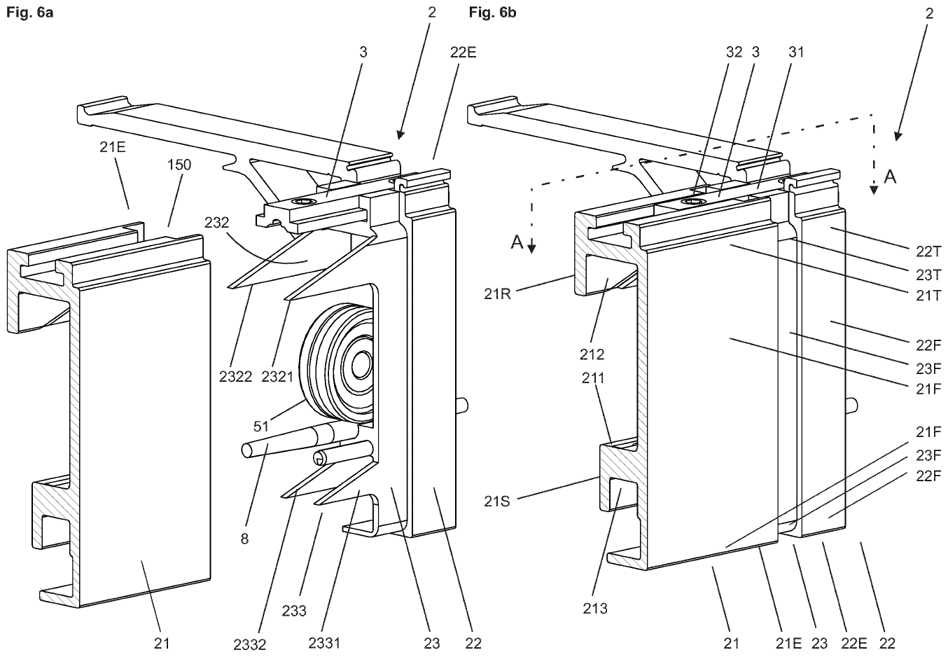

FIG. 6a the rail device 2 of FIG. 4 with the end piece 21E of the first rail section 21 detached from the rail adapter 23;

FIG. 6b the rail device 2 of FIG. 6a with the rail sections 21, 22 connected to each other at a specified distance by the rail adapter 23 and a connection device 3;

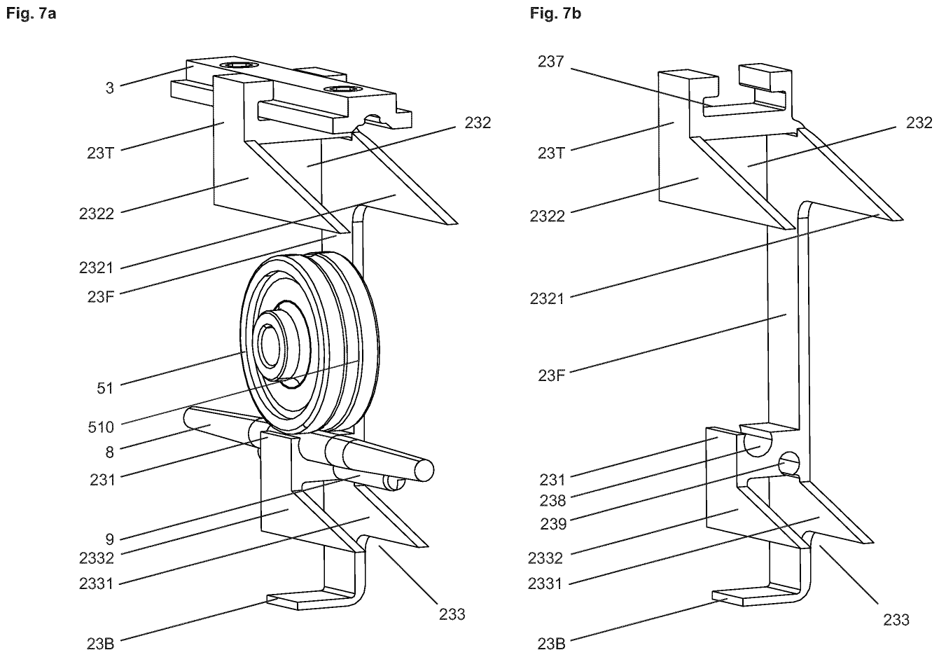

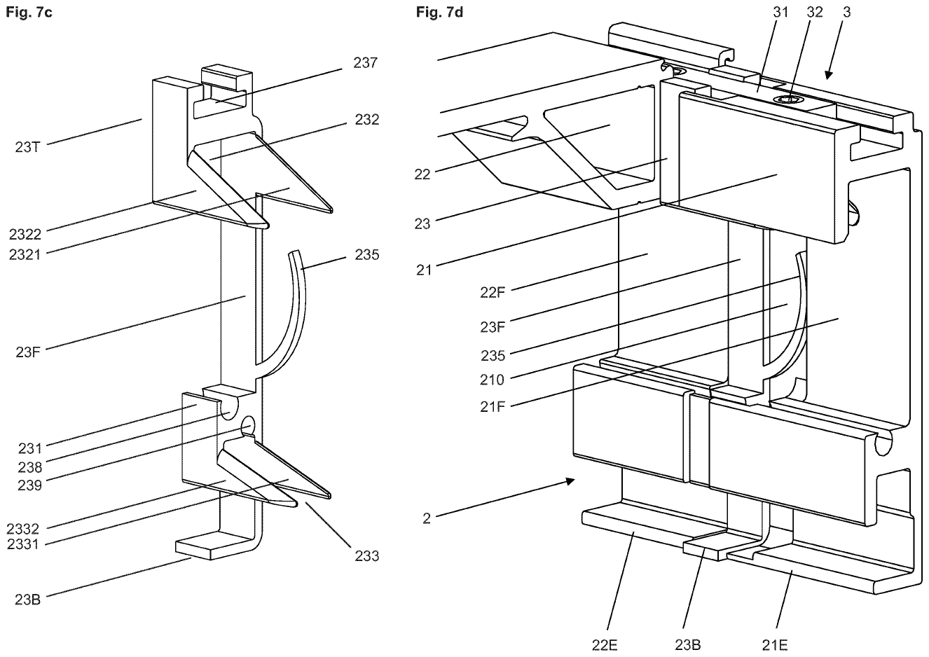

FIG. 7a the rail adapter 23 of FIG. 5 with a connection device 3 and a connecting rod 9, by means of which the two rail sections 21, 22 can be connected and with a runner bar 8, which is provided for engagement in the two rail sections 21, 22 and over which the Support roller 51 of the guide carriage 5 shown in FIG. 4a can roll;

FIG. 7 the rail adapter 23 of FIG. 7a without the connection device 3, the connecting rod 9 and the runner bar 8;

FIG. 7c the rail adapter 23 of FIG. 7b in a further preferred embodiment with a repulsion spring 235 provided on the front wall 23F;

FIG. 7d the rail adapter 23 of FIG. 7c inserted between the end pieces 21E, 22E of the first and second rail sections 21, 22;

FIG. 8a the rear side of the rail adapter 23 of FIG. 6a, which is partially inserted into a recess 210 in the facing end piece 21E of the first rail section 21;

FIG. 8b the rail adapter 23 of FIG. 8a, which is fully inserted into the recess 210 in the facing end piece 21E of the first rail section 21;

FIG. 8c the first rail section 21 of FIG. 8a with the end piece 21E, in which the recess 210 is machined;

FIG. 9a the rail adapter 23 and the first rail section 21 of FIG. 8a from above;

FIG. 9b the rail adapter 23 and the first rail section 21 of FIG. 8b from above;

FIG. 9c the first rail section 21 of FIG. 8c with the end piece 21E, in which the recess 210 is incorporated, shown from a different angle;

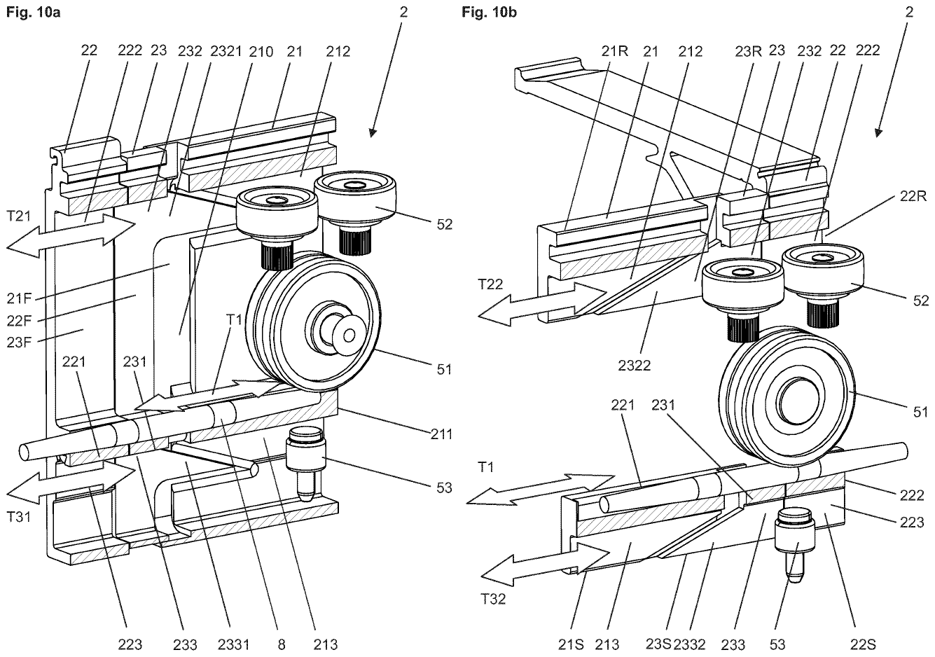

FIG. 10a the rail device 2 in sectional view along the sectional line A-A of FIG. 6b with a view of an inner side; and

FIG. 10b the rail device 2 in sectional view along the intersection line A-A of FIG. 6b with a view of another inner side.

FIG. 1 shows an inventive functional entity 1 in the embodiment of a piece of furniture 1 with a foldable door 11, which can be pushed into a first door compartment 10, and with a single-piece door 11′, which can be pushed into a second door compartment 10.

The piece of furniture 1 preferably has side walls 1A, an upper board 1B, a lower board 1C and partition walls 1D on both sides, which together with the side walls 1A delimit the door compartments 10.

The foldable door 11 has a first separating element or door element 111, which is connected on one side by mounting hinges 13 to a mounting profile 12, and on the other side by door hinges 14 to a second separating element or door element 112, the dimensions of which preferably correspond to the dimensions of the first door element 111. The foldable door 11 is slightly unfolded and can either be completely folded and retracted into the door compartment 10 with the door elements 111, 112 aligned parallel to one another or completely unfolded and moved into a closed position in which the two door elements 111, 112 are aligned at least approximately in one plane. In the embodiment of FIG. 1, the mounting profile 12 is held by a displacement device 19, which is shown schematically, and is displaceable within the associated door compartment 10. The doors 11 are aligned in front of the associated door compartment 10 parallel to the side wall 1A and can subsequently be displaced into the door compartment 10. For displacement within the door compartment 10, each mounting profile 12 can also be provided with drive devices. Preferably, the mounting profile 12 is connected at the top to a support carriage 15, which can be moved along an associated guide rail 16 into the door compartment 10. The mounting profile 12 can also be connected to a carriage on the underside, which is guided in a guide rail. The second door element 112 of the foldable door 11 is connected at the leading edge to a guide carriage 5, which is guided in a rail device 2, which is shown in fragments. The rail device 2 comprises a first rail section 21, which extends along an arc into the associated door compartment 10, and a second rail section 22, which extends along the front of the piece of furniture 1. The two rail sections 21, 22 are connected to each other by an inventive rail adapter 23 (see FIG. 5c). The rail adapter 23 can be shifted by a corresponding amount into a recess 210 provided in the facing end piece 21E of the first rail section 21 to compensate for tolerances when cutting the second rail section 22 or when manufacturing the piece of furniture 1. The second rail section 22 can therefore be supplied in a standard size and easily be installed in the rail device 2 by sliding the rail adapter 23 into the end piece 21E of the first rail section 21 as required.

Hence, the foldable door 11 is held at the front side by means of the guide carriage 5, which in the unfolded state of the foldable door 11 can be moved along the front side of the piece of furniture 1 and in the folded state of the foldable door 11 into the door compartment 10. In each case, the guide carriage 5 runs ahead of the second door element 112 in the direction of displacement.

FIG. 2 shows the rear side of the foldable door 11 of the functional entity 1 of FIG. 1 with the first door element 111, which in this embodiment is connected at the trailing edge by mounting hinges 13 to the mounting profile 12 and at the leading edge by door hinges 14 and mounting parts 17 to the second door element 112, on the front side of which the guide carriage 5 is mounted.

Also shown is the support carriage 15 connected to the mounting profile 12, which can be moved along the support rail 16. The guide carriage 5 and the support carriage 15 are each provided with a carriage body 54, 154, with a support roller 51, 151 and with two guide rollers 52, 152.

The rail device 2, in which the guide carriage 5 is guided, consists of two interconnected rail sections 21, 22. The rail device with the support rail 16 can also consist of several rail sections, which can be connected or are connected to one another by inventive rail adapters 23. By way of example, the invention is explained with reference to the rail device 2, which is provided for the guide carriage 5.

The two rail sections 21, 22 have corresponding cross-sections and each comprises a front wall 21F, 22F with a head piece 21T, 22T and a foot piece 21B, 22B. A support body 211, 221 is provided on each front wall 21F, 22F and a guide channel 212, 222 is provided in each head piece 21T, 22T. The support bodies 211, 221, which serve to support the support rollers 51 of the guide carriage 5, and the guide channels 212, 222, which serve to guide the guide rollers 52 of the guide carriage 5, are aligned coaxially to one another at the end faces and are connected to one another by the rail adapter 23. The schematically shown rail adapter 23 allows the rail sections 21, 22 to be moved relative to each other and also ensures a safe and stepless transition of the guide carriage 5 between the rail sections 21, 22.

FIG. 3 shows the rail device 2 and the guide carriage 5 of FIG. 2 in a preferred embodiment from the front. In this embodiment, the guide carriage 5 is additionally provided with a stabilisation roller 53 and a coupling device 55, by means of which the held door element 112 can be coupled. The axes of rotation of the guide rollers 52 and the axis of rotation of the stabilisation roller 53 are aligned perpendicular to the axis of rotation of the support roller 51.

It is shown that the support roller 51 can be supported on the support body 221 of the second rail section 22, whereby the guide rollers 52 can be inserted into the guide channel 222 and the stabilisation roller 53 into a stabilisation channel 223 on the underside of the support body 221. The load applied by the door element 112 is transferred to the rail device 2 via the support rollers 51. The guide rollers 52 ensure that the guide carriage 5 cannot rotate relative to the rail axis x. The guide rollers 52 and the stabilisation rollers 53 also ensure that the guide carriage 5 is held in vertical alignment.

However, the inventive rail device 2, which comprises the two rail sections 21, 22 connected to each other by the rail adapter 23, can also be realised for carriages in a different configuration. For example, it can be provided that the guide rollers 52 are arranged below the support roller 51 and guided in the stabilisation channel 223. The optionally provided stabilisation rollers 53, on the other hand, can be arranged above the support rollers 51 and guided in the guide channel 222.

In the present embodiment, the rail device 2 comprises a support track Tl, which is realised by the support bodies 211, 221 of the two rail sections 21, 22 and by a support body 231 of the rail adapter 23 (see FIG. 4). Furthermore, the rail device 2 comprises two guide tracks T21, T22, which are realised by the guide channels 212, 222 of the two rail sections 21, 22 and by a guide channel 232 of the rail adapter 23 (see FIG. 4). In addition, the rail device 2 comprises two stabilisation tracks T31, T32, which are realised by the stabilisation channels 213, 223 of the two rail sections 21, 22 and by a stabilisation channel 233 of the rail adapter 23 (see FIG. 4).

The rail adapter 23 is held between the facing end pieces 21E, 22E of the two rail sections 21, 22 and is preferably dimensioned in such a way that it always protrudes from the end piece 21E of the first rail section 21 and is visible. The first and second rail sections 21, 22 are preferably made of metal. The rail adapter 23 is preferably made of metal or plastic. The rail adapter 23 preferably has a colour that appears advantageously between the two rail sections 21, 22.

The two rail sections 21, 22 and the rail adapter 23 (see FIG. 4) preferably each have an installation channel 217, 227, 237, into which a connection plate 31 of a connection device 3 can be inserted, which can be braced by means of locking screws 32 in order to mutually fix the rail sections 21, 22 and the rail adapter 23 in a selected position.

It is shown that the rear end piece of the first rail section 21 is connected to a connecting rail 24 by a further connection device 3 and possibly a further rail adapter 23. The retaining rail 16 is connected to a bezel 161.

FIG. 4 shows the end piece 21E of the first rail section 21 of FIG. 3, which has a recess 210 for completely or partially receiving the rail adapter 23, the detached rail adapter 23 and the end piece 22E of the second rail section 22 facing the rail adapter 23.

It is shown that the two rail sections 21, 22 and the rail adapter 23 each have a front wall 21F, 22F, 23F, a head piece 21T, 22T, 23T, as well as an upper back piece 21R, 22R, 23R and a lower back piece 21S, 22S, 23S, which form channel walls of the guide channels 212, 222, 232 and the stabilisation channels 213, 223, 233.

Furthermore, it is shown (with regard to the first rail section 21, see also FIG. 8c) that the two rail sections 21, 22 and the rail adapter 23 each have a reception channel 218, 228, 238 and a mounting channel 219, 229, 239.

To connect the two rail sections 21, 22 with the rail adapter 23, a connecting rod 9 is inserted into the mounting channels 219, 229, 239. The mounting channels 219, 229, 239 preferably pass through the support bodies 211, 221, 231, which is why the support body 231 of the rail adapter 23 is kept stable by the connecting rod and can absorb the load acting via the support roller 51 without being deformed.

The connecting rod 9 also ensures that the support bodies 211, 222, 231 of the first and second rail sections 21, 22 and the rail adapter 23 are aligned coaxially with each other and form the support track T1, and that the guide channels 212, 222, 232 of the first and second rail sections 21, 22 and the rail adapter 23 are aligned coaxially with each other and form the first guide track T21 or the first and second guide tracks T21, T22. The support track T1 and the guide tracks T21, T22 therefore extend parallel to the rail axis x without steps and edges, even under the effect of the load.

It is also possible that the guide channels 212, 222, 232 only guide the guide rollers 52 of the carriage 5 on one side. It is also possible that the stabilisation channels 213, 223, 233 only guide the stabilisation rollers 53 on one side. The internal cross-sections of the guide channels 212, 222, 232 and the stabilisation channels 213, 223, 233 therefore preferably have the same internal cross-section in whole or in part. In preferred embodiments, the guide channels 212, 222, 232 and/or the stabilisation channels 213, 223, 233 exhibit a U-profile or an L-profile.

The reception channels 218, 228, 238, into which a runner bar 8 is inserted, are provided on the upper side of the support body 211, 221, 231 and are preferably open at the top. The runner bar 8 is preferably rotationally symmetrical and preferably tapers on both sides towards the neighbouring rail sections 21, 22, so that it has the largest diameter in the area of the rail adapter 23. For example, the runner bar 8 is cylindrical in the centre and conical on both sides.

Preferably, the runner bar 8 can protrude upwards out of the reception channels 218, 228, 238 or at least out of the reception channel 238 of the rail adapter 23 and thus co-operate with the support roller 51 of the carriage 5.

The support roller 51 therefore preferably moves onto the runner bar 8 within the end piece 21E of the first rail section 21 and only leaves the runner bar 8 after reaching the second rail section 22. Preferably, the support roller 51 has a circumferential ring groove 510 approximately in the centre, into which the runner bar 8 can enter. The support roller 51 is thus securely supported in the transition area and also guided laterally.

The runner bar 8 can also form a part of the support track T1 in another way and connect flush or almost flush to the top of the support body 231 and take up the load of the support roller 51. In this embodiment, the runner bar 8 preferably has a rectangular cross-section in the area of the reception channel 238, so that a support roller 51 that does not have a ring groove 51 is optimally supported.

The end piece 21E of the first rail section 21 has a recess 210 into which the rail adapter 23 can be inserted. In the area of the guide channel 232, the rail adapter 23 has a guide wing 2321 on one side or a guide wing 2321, 2322 on both sides. In the area of the stabilisation channel 233, the rail adapter 23 has a stabilisation wing 2331 on one side or a stabilisation wing 2331, 2332 on both sides. The guide wing 2321 or the guide wings 2321, 2322, which are triangular in this embodiment, form extensions of the guide channel 232 of the rail adapter 23 and at the same time parts of the guide channel 212 within the first rail section 21. The stabilisation wing 2331 or the stabilisation wings 2331, 2332, which in this embodiment are triangular in shape, form extensions of the stabilisation channel 233 of the rail adapter 23 and at the same time parts of the stabilisation channel 213 within the first rail section 21, as shown in FIG. 10a and FIG. 10b.

FIG. 5a shows the rail device 2 of FIG. 3 with the second rail section 22 in sectional view and with guide carriage 5 inserted.

FIG. 5b shows the rail device 2 of FIG. 3 with the second rail section 22 detached from the rail adapter 23.

FIG. 5c shows the rail device 2 of FIG. 3 with the released rail adapter 23, from which the first rail section 21 and the second rail section 22 are detached.

FIG. 6a shows the rail device 2 of FIG. 4 with the end piece 21E of the first rail section 21 detached from the rail adapter 23.

FIG. 6b shows the rail device 2 of FIG. 6a with the rail sections 21, 22 connected to each other by the rail adapter 23 and a connection device 3 at a specified distance. It can be seen that manufacturing tolerances can easily be compensated for by means of the rail adapter 23. It can also be seen that the offset rail adapter 23 can stand out in a visually striking way by means of appropriate colouring.

FIG. 7a shows the rail adapter 23 of FIG. 5 with a connection device 3 and a connecting rod 9, by means of which the two rail sections 21, 22 are connectable to each other and with a runner bar 8, which is provided for engagement in the two rail sections 21, 22 and over which the support roller 51 of the guide carriage 5 of FIG. 5a can roll. The connecting rod 9 inserted into the support body 231 is also shown. The guide wings 2321, 2322 delimit the guide channel 232 and the stabilisation wings 2331, 2332 delimit the stabilisation channel 233 and extend it in one direction. If recesses 210 are provided in the end pieces 21E, 22E in both rail sections 21, 22, the rail adapter 23 is preferably formed symmetrically, with guide wings 2321, 2322 and stabilisation wings 2331, 2332 pointing in opposite directions.

FIG. 7b shows the rail adapter 23 of FIG. 5 without the connection device 3, the connecting rod 9 and the runner bar 8. This base body of the rail adapter 23 can advantageously be manufactured as a die-cast part from a plastic compound.

FIG. 7c shows the rail adapter 23 of FIG. 7b in a further preferred embodiment with a repulsion spring 235 provided on the front wall 23F, which engages in the recess 210 in the facing end piece 21E of the first rail section 21 and rests within the recess 210 against the front wall 21F of the first rail section 21 and exerts a recoil force on the rail adapter 23 and presses it against the end face of the second rail section 22. After the rail adapter 23 has been inserted into the recess 210 and the two rail sections 21, 22 are moved towards each other, the rail adapter 23 therefore always lies flush against the end face of the second rail section 22.

Preferably the rail adapter 23 is therefore provided or connected preferably in one piece with at least one adapter part, which serves to connect the rail adapter 23 positively and/or non-positively to the second rail adapter 22.

At least one adapter part can be provided that pushes the rail adapter 23 against the second rail section 22 or pulls it against the second rail section 22. The end piece 22E of the second rail section 22 can, for example, be positively connectable to the rail adapter 23 and, for this purpose, can be provided with recesses in which an adapter part engages.

FIG. 7d shows the rail adapter 23 of FIG. 7c inserted between the end pieces 21E, 22E of the first and second rail sections 21, 22. The rail adapter 23 is held by the adapter part or the repulsion spring 235 on the end face of the end piece 22E of the second rail section 22, so that the connection device 3 can be fixed by tightening the screw 32 without first accessing the rail adapter 23.

FIG. 8a shows the rear side of the rail adapter 23 of FIG. 6a, which is partially inserted into the recess 210 in the facing end piece 21E of the first rail section 21.

FIG. 8b shows the rail adapter 23 of FIG. 8a, which is fully inserted into the recess 210 in the facing end piece 21E of the first rail section 21.

FIG. 8a and FIG. 8b therefore illustrate the process of adjusting the rail adapter 23, which is moved into the recess 210 in the end piece 21E as required.

Due to the shape of the guide wings 2321, 2322 and the stabilisation wings 2331, 2332, it is ensured that the guide rollers 52 and the stabilisation rollers 53 are always securely guided on one or both sides within the guide channel 212 of the first rail section 21 and the guide channel 232 of the rail adapter 23 as well as within the stabilisation channel 213 of the first rail section 21 and the stabilisation channel 233 of the rail adapter 23. In the transition area, the guide rollers 52 and the stabilisation rollers 53 are guided through both the first rail section 21 and the rail adapter 23. FIG. 8c shows the first rail section 21 of FIG. 8a with the end piece 21E, in which the recess 210 is incorporated, which comprises various receiving parts. The recessed part 2123T, into which the head part 23T of the rail adapter 23 can enter, is recessed in the head part 21T.

Adjacent to the recessed part 2123T in the head piece 21T are recessed parts 212321, 212322 in the front wall 21F and in the upper back piece 21R, into which the guide wings 2321, 2322 of the rail adapter 23 can enter.

The recessed part 21231, into which the support body 231 of the rail adapter 23 can enter, is recessed in the support body 211.

Adjacent to the recessed part 21231 in the support body 211 are recessed parts 212331, 212332 in the front wall 21F and in the lower back piece 21s, into which the stabilisation wings 2321, 2322 of the rail adapter 23 can enter.

A recess 2123F is also inserted into the front wall 21F, into which the front wall 23F of the rail adapter 23 can enter.

FIG. 9a shows the rail adapter 23 and the first rail section 21 of FIG. 8a from above.

FIG. 9b shows the rail adapter 23 and the first rail section 21 of FIG. 8b from above.

FIG. 9c shows the first rail section 21 of FIG. 8c with the end piece 21E, in which the recess 210 is incorporated, from an angle showing the recessed parts 212321, 212322.

FIG. 10a shows the rail device 2 in sectional view along the sectional line A-A of FIG. 6b with a view of the rear side of the front wall 21F, 22F, 23F of the first and second rail section 21, 22 and the rail adapter 23.

FIG. 10b shows the rail device 2 in sectional view along the sectional line A-A of FIG. 6b with a view of the rear side of the upper back piece 21R, 22R, 23R and the lower back piece 21S, 22S, 23S of the two rail sections 21, 22 and the rail adapter 23.

Also shown are the support track T1, the guide tracks T21, T22 and the stabilisation tracks T31, T32, which extend uninterruptedly and continuously through the rail device 2, irrespective of the set mutual distance between the two rail sections 21, 22.

### LIST OF REFERENCES

1 functional entity, piece of furniture, e.g. wardrobe
1A side walls
1B upper board
1C lower board
1D separation wall
10 first or second door compartment 10 or parking space
100 interior of the functional entity 1
11 foldable door
111 first door element
112 second door element
11′ one-part door
12 mounting profile
13 mounting hinges
14 door hinges
15 support carriage
151 support rollers
152 guide rollers
154 carriage body
16 support rail
161 bezel
17 mounting part, hinge cup
19 displacement device
2 rail device
21 first rail section
210 recess
2123B recessed part in the foot piece
2123F recessed part in der front wall
2123T recessed part in the head piece
212321, 212322 recessed parts in the guide channel 212
212331, 212332 recessed parts in the stabilisation channel 213
21B foot piece
21E end piece of the first rail section 21
21F front wall
21R upper back piece
21S lower back piece
21T head piece
211 support body
212 guide channel
213 stabilisation channel
217 mounting channel
218 reception channel
219 mounting channel
22 second rail section
22B foot piece
22E end piece of the second rail section 22
22F front wall
22R upper back piece
22S lower back piece
22T head piece
221 support body
222 guide channel
223 stabilisation channel
226 installation plate
227 installation channel
228 reception channel
229 mounting channel
23 adjustable rail adapter
23B foot piece
23F front wall
23R upper back piece
23S lower back piece
23T head piece
231 support body
232 guide channel
2321 first guide wing
2322 second guide wing
233 stabilisation channel
2331 first stabilisation wing
2332 second stabilisation wing
235 repulsion spring
237 installation channel
238 reception channel
239 mounting channel
24 terminating rail
3 connection device
31 connection plate
32 locking screws
5 guide carriage
51 support roller
510 ring groove
52 guide rollers
53 stabilisation roller
54 carriage body
55 coupling device
8 runner bar
9 connecting rod
T1 support track
T21, T22 guide tracks
T31, T32 stabilisation tracks
X rail axis

1. A rail device with a rail, axis, along which a carriage is guidable, which has a support roller and two guide rollers, comprising
a first rail section with a first support body, and a first guide channel,
a second rail section with a second support body and a second guide channel, and
a connection device by means of which end pieces of the two rail sections, which are facing one another, are interconnected,
wherein the rail device comprises a rail adapter, by means of which the first rail section and the second rail section are connectable to one another at a selectable mutual distance,
that the rail adapter has a third support body, and a third guide channel,
that the end piece of the first rail section has a recess into which the rail adapter is completely or partially displaced,
that the first, second and third support bodies are aligned coaxially with each other and form a support track which serves to support the support rollers, and
that the first, second and third guide channels are aligned coaxially to one another and have a completely or partially identical internal cross-section and form a first guide track or a first and a second guide track, which serve to guide the guide rollers.

2. The rail device according to claim 1, wherein the first rail section comprises a first front wall, on which the first support body is provided, and a first head piece, in which the first guide channel is provided;
that the second rail section comprises a second front wall, on which the second support body is provided, and a second head piece, in which the second guide channel is provided; and
that the rail adapter comprises a third front wall, on which the third support body is provided, and a third head piece, in which the third guide channel is provided.

3. The rail device according to claim 1, wherein the rail device is adapted to guide a carriage which comprises a support roller, two guide rollers and a stabilisation roller, and that the first rail section comprises a first stabilisation channel, the second rail section comprises a second stabilisation channel and the rail adapter comprises a third stabilisation channel, which stabilisation channels are aligned coaxially to one another and have a completely or partially identical internal cross-section and form a first stabilisation track or a first and a second stabilisation track, which serve to guide the stabilisation rollers.

4. The rail device according to claim 3, wherein the first stabilisation channel is provided in the first support body, that the second stabilisation channel is provided in the second support body and that the third stabilisation channel is provided in the third support body.

5. The rail device according to
wherein the rail adapter in its dimensions is completely or partially complementary to the recess in the end piece of the first rail section, or
that the rail adapter in its dimensions is completely or partially complementary to the recess in the end piece of the first rail section, and that the rail adapter which is inserted into the end piece of the first rail section protrudes from the end piece of the first rail section or is completely received therein.

6. The rail device according to claim 1, wherein the first rail section has a first recessed part in the first guide channel, into which a complementary and outwardly tapering guide wing of the third guide channel of the rail adapter projects, or
that the first rail section has a first and a second recessed part on opposite sides in the first guide channel, into which complementary and outwardly tapering guide wings of the third guide channel of the rail adapter project.

7. The rail device according to claim 2, wherein the first rail section has a third recessed part in the first stabilisation channel, into which a complementary and outwardly tapering stabilisation wing of the third stabilisation channel of the rail adapter projects, or
that the first rail section has a third and a fourth recessed part on opposite sides in the first stabilisation channel, into which stabilising wings of the third stabilisation channel of the rail adapter, which wings are complementary thereto and taper outwards, project.

8. The rail device according to claim 6, wherein the guide wings each have two flanks inclined towards each other, or
that the stabilisation wings each have two flanks inclined towards each other, or
that the guide wings and the stabilisation wings each have two flanks inclined towards each other.

9. The rail device according to claim 1, wherein the support bodies of the first and second rail sections and of the rail adapter have a reception channel into which a runner bar is inserted, which projects beyond the third support body of the rail adapter.

10. The rail device according to claim 1, wherein the first and second rail sections and the rail adapter, which are coaxially aligned with one another, each have at least one mounting channel, into which mounting channels a connecting rod is inserted, or
that the support bodies of the first and second rail sections and of the rail adapter, which are aligned coaxially to one another, each have at least one mounting channel, into which mounting channels, a connecting rod is inserted.

11. The rail device according to claim 1, wherein the head pieces of the first and second rail sections and of the rail adapter each have an installation channel, which installation channels are aligned coaxially to one another, that the connection device has a connection plate and locking screws held rotatably in the connection plate, and that the connection plate is held axially displaceably in the installation channels and is fixed by means of the locking screws.

12. The rail device according to claim 1, wherein the first and second rail sections each extend straight or at least partially along a curve or that the first rail section extends straight and the second rail section extends at least partially along a curve.

13. The rail device according to claim 1, wherein the facing end pieces of the first and second rail section have the same structure and the rail adapter is adapted to both end pieces or that the end piece of the second rail section and the rail adapter lie end to end in one plane.

14. The rail device according to claim 1, wherein the first and the second rail sections are made of metal and that the rail adapter is made of metal or plastic, or
that the first and the second rail sections are made of metal and that the rail adapter is made of metal or plastic and provided with a colour.

15. A functional entity with a rail device according to claim 1.
